(19) United States
(12) Patent Application Publication
(10) Pub. No.: US 2014/0375993 A1
(43) Pub. Date: Dec. 25, 2014

(54) Bicycle Alignment Device

(71) Applicant: Maxwell David Kettle, Axe Creek (AU)

(72) Inventor: Maxwell David Kettle, Axe Creek (AU)

(21) Appl. No.: 14/288,490

(22) Filed: May 28, 2014

(30) Foreign Application Priority Data
Jun. 23, 2013 (AU) 2013902290
Jan. 31, 2014 (AU) 2014900285

(51) Int. Cl. G01B 11/27

(52) U.S. Cl. CPC G01B 11/27
USPC 356/400; 33/286

(57) ABSTRACT

An alignment device for bicycle handlebars that enables them to be accurately aligned relative to the front wheel. The device may include a unitary body and a laser beam emitter. The laser beam emitted may create a visible point of light wherever the beam makes contact with the front wheel, or the bicycle frame, or another component attached to the bicycle frame. The laser beam can be perpendicular to the handlebars. The laser beam emitter is preferably able to be changed by the user. Using the laser beam, and by adjusting the beam's angle of declination or inclination, the user can preferably make fine adjustments to the alignment of the handlebars, relative to the front wheel, and/or another component that is mounted on the bicycle frame, relative to the bicycle frame.

### CROSS REFERENCE TO RELATED APPLICATIONS

This application claims priority to the following patent applications: (1) Australian Patent Application No. 2013902290 filed Jun. 23, 2013 and (2) Australian Patent Application No. 2014900285 filed Jan. 31, 2014; each of the above cited applications is hereby incorporated by reference herein as if fully set forth in its entirety.

### FIELD OF THE INVENTION

This invention relates to bicycles, and devices used to align the handlebars relative to the front bicycle wheel, as well as devices used to align other attached components to a bicycle frame.

### BACKGROUND OF THE INVENTION

It is important that when assembling a bicycle, or maintaining an assembled bicycle, that the handlebars are accurately aligned with the front wheel, and that other components attached to the bicycle frame, such as the bicycle seat for example, are precisely aligned. In many bicycle workshops, this is done by eye, and there is no way to accurately determine if the handlebars are in proper alignment with the front wheel.

This is a more significant problem in relation to bikes used in competition where the bicycle needs to be properly aligned to ensure maximum performance from the rider. Not only do the handlebars need to be properly aligned, but so do all the other components of the bicycle, including the seat and the front and rear wheels.

It is an object of the present invention to provide bicycle alignment device that at least ameliorates the above-mentioned problems.

### DISCLOSURE OF THE INVENTION

Accordingly, the present invention is a device for aligning the handlebars of a bicycle relative to the bicycle's front wheel, the device includes a unitary body and a laser beam emitter. The unitary body includes a base portion that enables the unitary body to at least sit upon the handlebars. The base portion provides the device with a stable and accurate foundation upon which the device is able to be operated by a user. The laser beam emitter generates a beam in the visible light spectrum so that wherever the beam makes contact with the front wheel, or the bicycle frame, or another component attached to the bicycle frame, it creates a visible point of light. The laser beam emitter is mounted inside the unitary body on a first transverse shaft, and the first transverse shaft runs parallel to the handlebars, so that the laser beam emitted from said laser beam emitter is perpendicular to the first transverse shaft. The laser beam emitter is capable of being rotated inside the unitary body about the first transverse shaft, so that the angle of declination or inclination that the emitted laser beam produced by the laser beam emitter makes relative to the handlebars is able to be changed by the user, thereby causing the visible point of light to be movable by the user. Using the generated beam, and by adjusting the beam's angle of declination or inclination, the user can then make fine adjustments to the alignment of the handlebars, relative to the front wheel, and/or another component that is mounted on the bicycle frame, relative to the bicycle frame.

Preferably the base portion is located at the lower end of the unitary body and consists of a pair of forks that overlay the top of the handlebars.

Optionally the unitary body includes an alternative engagement portion that extends laterally to the vertical axis of the unitary body, and when used, the alternative engagement portion permits the user to place the device onto the front or rear of the handlebars while ensuring stable support for the device, relative to the handlebars, and also ensuring the transverse shaft remains parallel with the handlebars.

Optionally the alternative engagement portion includes a pair of spring biased slidable clamps that are capable of being opened by an operator, allowing the operator to place the device on the handlebars, with a portion of the handlebars located within the pair of clamps, so that when the clamps are released, the resulting clamping action upon the portion of the handlebars is sufficient to hold the device in place.

Preferably at least the handlebar contacting surfaces of the device are fabricated from a material that mitigates the likelihood that the contact between the device and the handlebars will damage or mar the surface finish of the handlebars, regardless of the material from which the handlebars are fabricated.

Preferably once the handlebars are precisely aligned, relative to the front wheel, and the front wheel is precisely aligned relative to the bicycle, the emitted laser beam can then be used to align other components attached to the bicycle frame, such as a bicycle seat for example.

Preferably there are fine adjustment means included to adjust the angle of the first transverse shaft relative to the handlebars, to enable the user to adjust the direction of the emitted laser beam to ensure it is perpendicular to the line of the handlebars at all angles of inclination and declination.

Preferably the unitary body includes additional attachment means that enable the device to be removably attached to the handlebars.

Preferably the additional attachment means are elastic straps that are attached to the unitary body at one end, and then once the device is placed into contact with the handlebars, the elastic straps are able to be stretched around the handlebars, then re-attached to the unitary body at the other end, thereby holding the unitary body in contact with the handlebars.

Optionally a first mirror can be installed at a desired location on the bicycle so that the laser beam emitted from the laser beam emitter can be reflected off the first mirror to a location on the bicycle frame, or a component attached to the frame, that the direct beam generated by the laser emitter would not be able to contact directly due to an obstruction by either the bicycle frame, or a component attached to the frame.

Preferably the first mirror is attached to a second transverse shaft, and the second transverse shaft is calibrated to run parallel to the handle bars so that the laser beam reflected off the mirror remains perpendicular to the handlebars.

Preferably the first mirror is rotatable about the second transverse shaft so that the angle of inclination or declination of the reflected laser beam can be adjusted by the user, thereby causing the point of light generated by the reflected laser beam on either the frame or a component attached to the frame, to be movable.

Optionally a second mirror is installed at another desired location on the bicycle so that the reflected laser beam from the first mirror is able to be directed onto the second mirror so that the laser beam emitted from the laser beam emitter can be reflected off the second mirror to a location on the frame, or a component attached to the frame, that the direct beam generated by either the laser emitter, or the beam reflected off the first mirror, would not be able to contact directly due to an obstruction by either the bicycle frame, or a component attached to the frame.

Preferably the second mirror is attached to a third transverse shaft, and the third transverse shaft is calibrated to also run parallel to the handle bars so that the laser beam reflected off the second mirror remains perpendicular to the handlebars.

Preferably the second mirror is rotatable about the third transverse shaft so that the angle of inclination or declination of the reflected laser beam off the second mirror can be adjusted by the user, thereby causing the point of light generated by the reflected laser beam on either the frame or a component attached to the frame, to be movable.

Preferably the first mirror is located near a forward portion of the bicycle frame, or a component attached to the frame, such as the front forks, and the second mirror is located near a rearward portion of the bicycle frame, or a component attached to the frame, so that the laser beam generated by the laser beam emitter can be used to check the “squareness” of the bicycle frame.

Preferably the device uses the centre bolt on the handlebar stem for its mounted position.

### BRIEF DESCRIPTION OF THE DRAWINGS

FIG. 1 is side view of the present invention showing the optional alternative engagement portion

FIG. 2 is a top view of the present invention without the optional alternative engagement portion shown

FIG. 3 is a side view of the present invention illustrating the arc of the emitted laser beam.

FIG. 4 shows an alternative embodiment of the invention using mirrors to enhance the effectiveness of the invention.

FIG. 5 shows a side view of an alternative embodiment of the invention that includes adjustment means

FIG. 6 shows a side view of an alternative embodiment of the invention that includes a pair of clamps.

FIG. 7 shows a front view of an alternative embodiment of the invention with variable width engagement means.

FIG. 8 shows another alternative embodiment of the invention with alternative engagement means that are suitable for non-standard shaped handlebars, such as those used on triathlon bicycles.

### DETAILED DESCRIPTION OF THE PREFERRED EMBODIMENTS

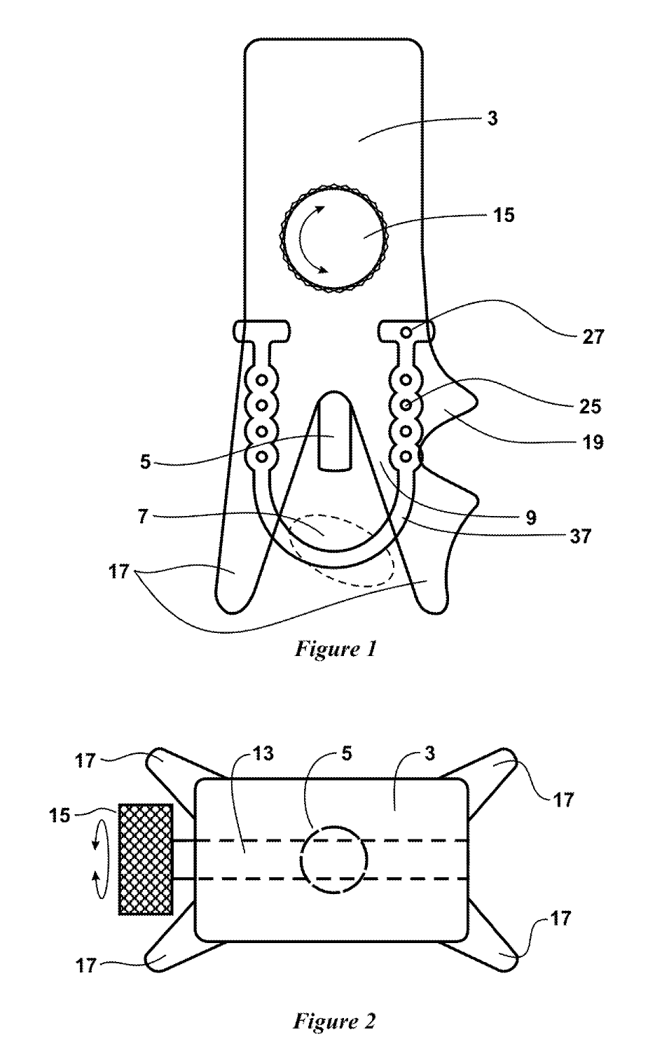

Turning firstly to FIG. 1, we can see the bicycle alignment device of the present invention. In the embodiment shown in this view, the device has a unitary body 3 that includes a base portion 9. In this embodiment, the base portion 9 is shown as a pair of forks 17. When in use, the user of the device is able to position the device in the appropriate place on the handlebars 7 which are shown in dotted outline. The user places the forks 17 upon the top of the handlebars 7. This gives the device a stable support upon which the device can be operated by the user. Preferably the appropriate location on the handlebars 7 is determined by the position of the centre bolt that connects the stem to the handlebars.

Once the device is in place, it can be optionally removably fixed in place by the use of a pair of elastic straps 25. One end of the elastic straps 25 is fixed to the unitary body 3, and the other is removably connectable to connecting pin 27. Each elastic strap 25 has a plurality of holes 37 that engage with the connecting pin 27. To temporarily mount the device to the handlebars 7, the user first locates the device in the appropriate place on the handlebars 7, then stretches each elastic strap 25 around the underside of the handlebars 7 and then temporarily fixes the free end of the strap 25 by attaching the most appropriate hole 37 in the strap 25 to the connector pin 27.

The laser beam emitter 5 is housed within the unitary body on first transverse shaft 13 (best shown in FIG. 2). In this view, the laser beam emitter 5 is shown pointing directly downwards. But the laser beam emitter 5 is free to rotate about the first transverse shaft 13 by direct manipulation of the beam angle adjustment knob 15. Turning the knob 15 causes the laser beam emitter 5 to rotate about the first transverse shaft 13.

The laser beam emitted by the laser beam emitter 5 is in the visible light spectrum, therefore wherever the beam makes contact with an object, such as the front wheel, or the bicycle frame, or some other component attached to the bicycle frame, it produces a visible point of light at the point of contact. Turning the knob therefore moves this visible point of light to any desired location on the front wheel, the bicycle frame, or on a component attached to the frame.

By manipulating the beam angle adjustment knob 15, the user can move the beam along the tyre of the front wheel, thereby ensuring that the handlebars are precisely aligned with the front wheel.

Once the handlebars 7 are adjusted into place, relative to the front wheel, and then when the front wheel is precisely aligned relative to the bicycle frame, then the user can adjust the angle of the beam so that other components attached to the bicycle frame, like the bike seat for example, can be precisely aligned.

In some cases, it is not always desirable to place the device on top of the handlebars 7 due to many factors such as the shape of the handlebars for example. In this embodiment, an alternative engagement portion 19 is shown, which enables the user to place the device on either the front or rear of the handlebars 7 instead of on top.

Turning to FIG. 2 we see a top view of another embodiment of the present invention showing the first transverse shaft 13 in dotted outline that the laser emitter 5 is mounted upon. We can see that the shaft 13 extends externally to the unitary body 3, and is connected to the turning knob 15.

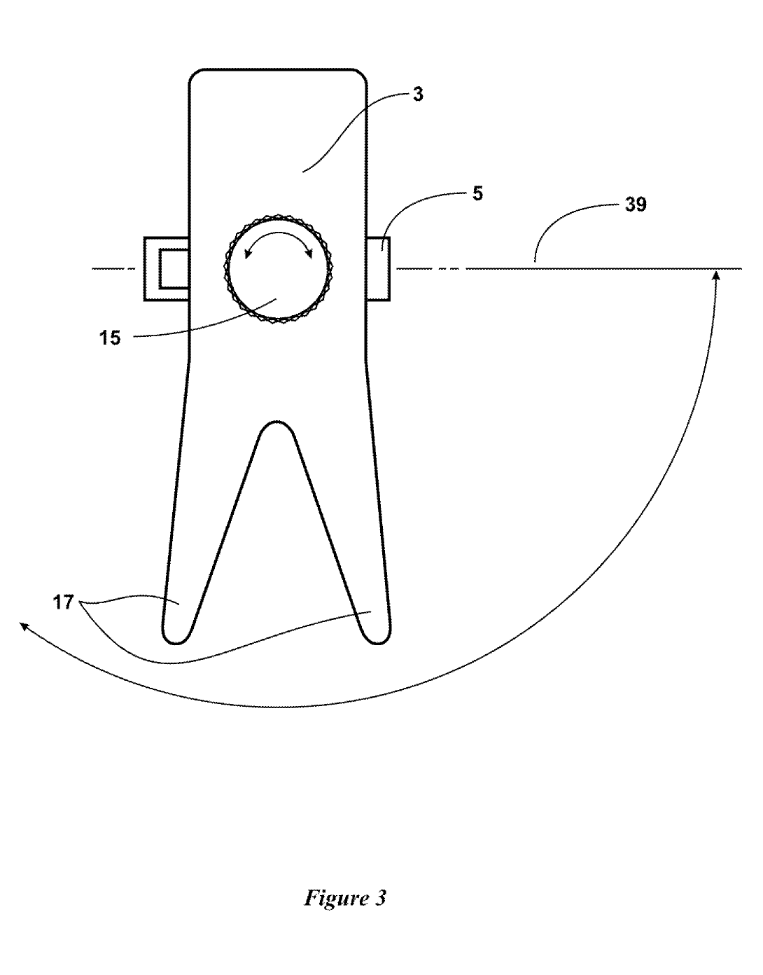

Turning to FIG. 3 we can see a side view of a simple embodiment of the present invention showing a portion of the entire arc that the laser beam 39 can be manipulated into. This arc is shown by the large arrow.

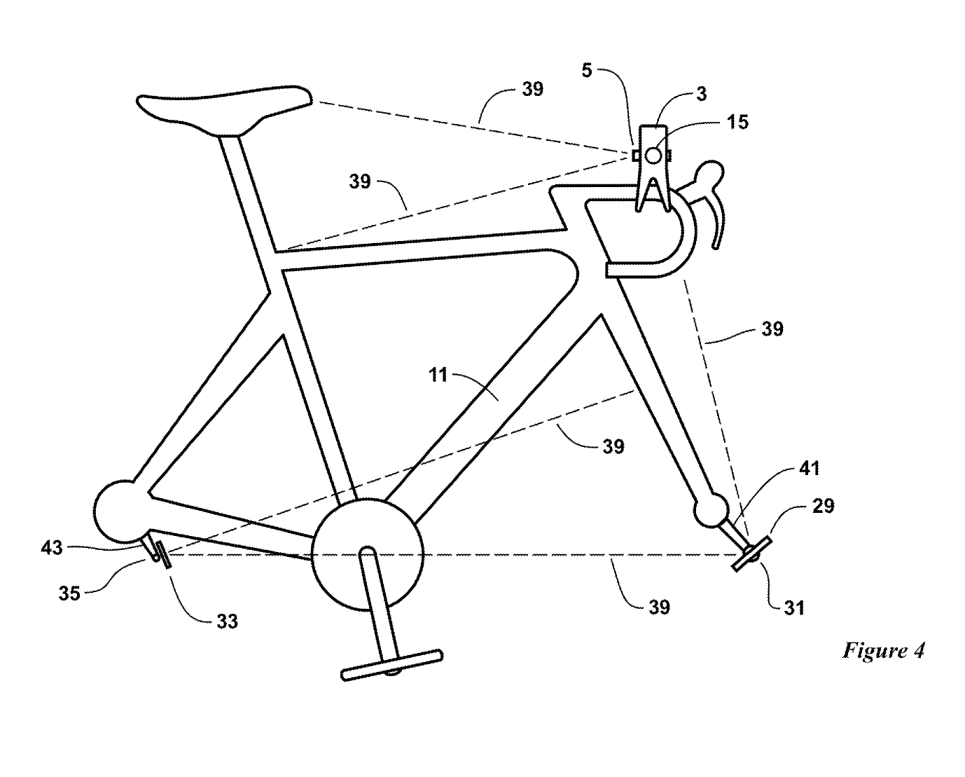

FIG. 4 shows yet another embodiment of the present invention. In this embodiment, a first remote mirror 29 and a second remote mirror 33 are fixed at desired locations upon the bicycle frame 11. The first remote mirror 29 is attached to the bicycle frame 11 via first mirror mounting means 41. The first remote mirror 29 is mounted on a second transverse shaft 31 that allows the user to rotate the first remote mirror 29 so that the direction of any laser beam 39 that is reflected off of the mirror can be adjusted.

Optionally a second remote mirror 33 is also mounted to the frame 11. It is connected to the frame 11 by the second mirror mounting means 43. Just like with the first mirror 29, the second remote mirror 33 is mounted on a third transverse shaft 35 which enables the user to adjust the direction of any laser beam 39 that is reflected off the second mirror 33.

Using this arrangement, the user can direct the beam to locations on the frame 11, or onto a component attached to the frame, that could not otherwise be reached directly by the beam 39. This arrangement also gives a user a means to check the integrity of the frame 11 and to check if there is any buckling or warping.

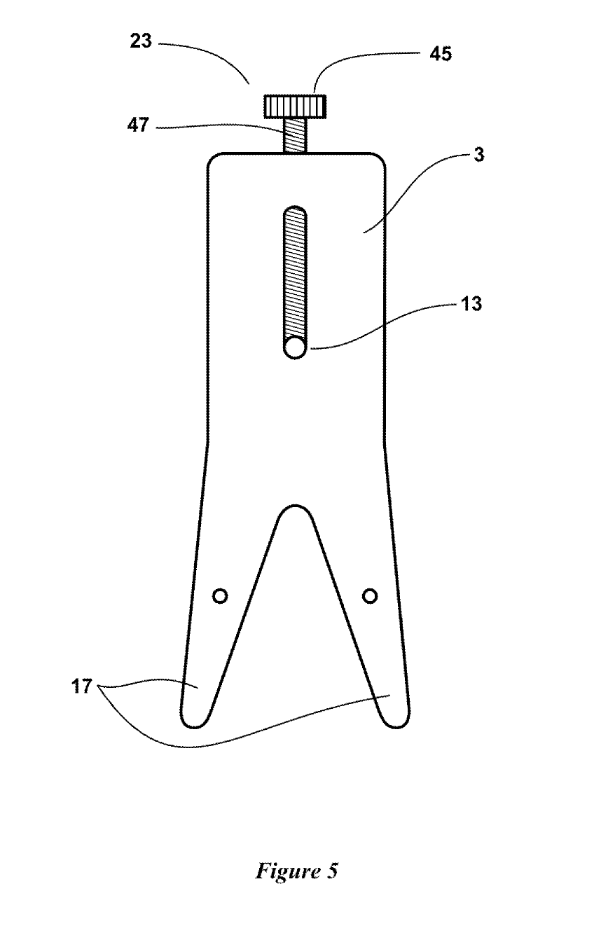

Turning to FIG. 5, we are shown an optional embodiment wherein a fine adjustment means 23 is provided for the first transverse shaft 13. This allows a user of the device to make fine adjustments to the angle that the first transfer shaft 13 makes in relation to the unitary body 3. In order for the invention to work effectively, it needs to be calibrated so that the beam produced by the laser beam emitter 5 is perpendicular to the handlebars 7. In order to achieve this, the first transverse shaft 13 needs to be parallel to the handlebars. The fine adjustment means 23 allow the user to compensate for any anomalies affecting the angle of the first transverse shaft 13 relative to the handlebars. One end of the first transverse shaft 13 is housed within a bush, and the bush is connected to a threaded adjustment shaft 47 that extends vertically through the unitary body, and extends out of the top of the device. The end of the threaded adjustment shaft 47 is connected to an adjustment knob 45. Turning the knob in one direction causes the first transverse shaft 13 to rise up a little, and turning it in the other direction causes the first transverse shaft 13 to lower a little.

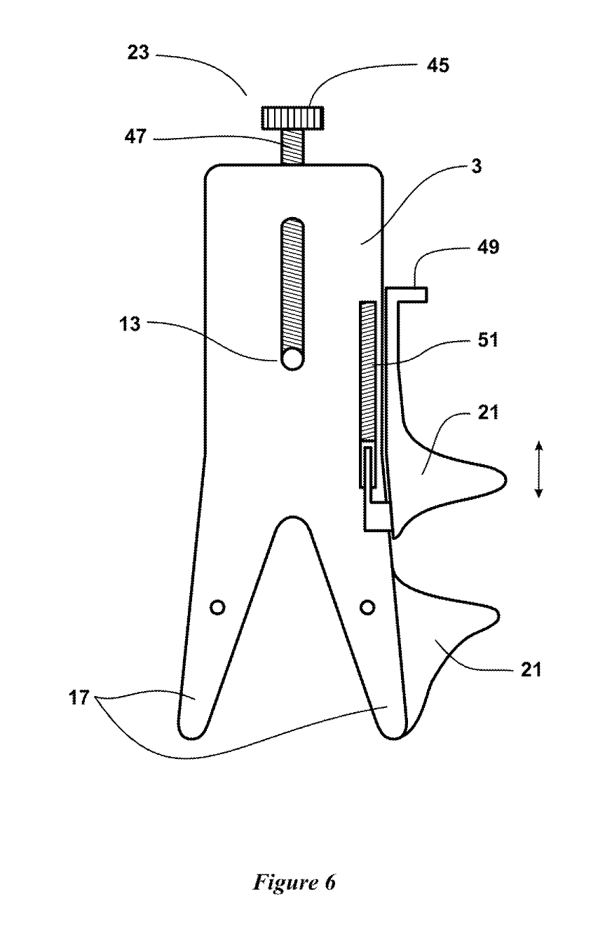

In FIG. 6 we can see yet another embodiment wherein a pair of clamps 21 are included. This gives the user another way of temporarily connecting the device to either the front or rear side of the handlebars 7. When used, the user can force part of the clamp 21 upwardly via clamp actuator 49. The upper jaw of the clamp is slidably engaged within a slot in the unitary body 3. Within the unitary body is a spring 51 so that when the user forces the top jaw of the clamp 21 upwardly, it compresses the spring 51. Once the device is placed upon the handlebars 7 at the appropriate location, the user can then release the actuator 49 causing the clamp to close upon the handlebars 7. The clamping action is sufficient to hold the device in place during operation of the device.

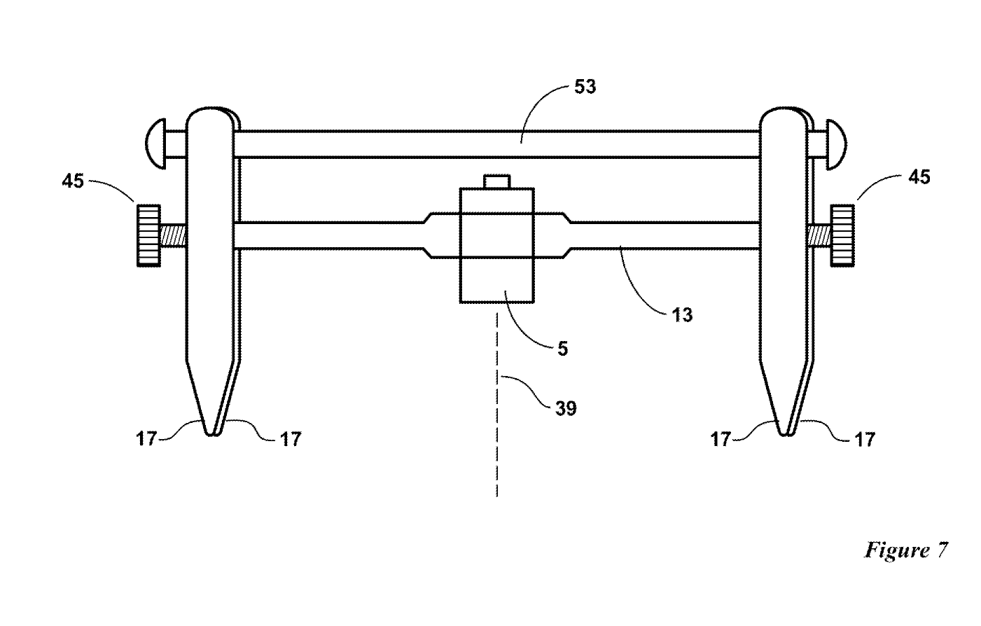

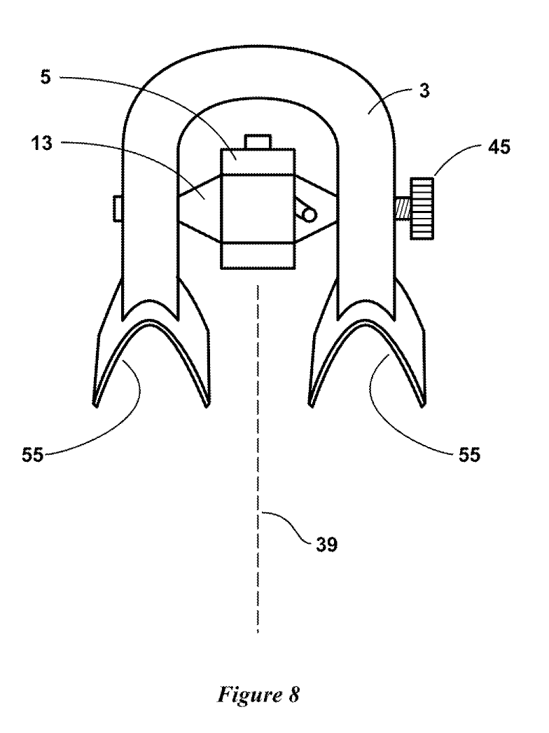

In FIG. 7 we are shown yet another embodiment of the present invention. This embodiment includes adjustable engagement means that allow a user to adjust the distance between the forks 17. The laser beam emitter 5 sits on the first transverse shaft 13, and the angles of the beam 39 can still be adjusted by turning the knob 45. In this embodiment, there is included a transverse alignment bar 53. The transverse alignment bar 53 has a square, rectangular or triangular profile that ensures that each pair of forks 17 are in alignment with respect to one another.

Finally in FIG. 8 we are shown an alternative embodiment wherein the forks are replaced with a pair of saddles 55. This makes it easy to place the device onto unusually shaped handlebars 7, like those that are used on triathlon bicycles for example.

At least the portions of the unitary body 3 that come into direct contact with the handlebars 7 is fabricated from a suitable material that mitigates the risk of damage, blemishes or marring of the surface finish of the handlebars 7.

In use, the user is able to control the direction of the perpendicular beam 39 emitted from the laser beam emitter 5 to a wide variety of locations on the bicycle frame 11, the front and rear wheels, the bicycle seat etc.

The variety of attachment modes enables the device to be used on a wide variety of styles and shapes of handlebars 7.

While the above description includes the preferred embodiments of the invention, it is to be understood that many variations, alterations, modifications and/or additions may be introduced into the constructions and arrangements of parts previously described without departing from the essential features or the spirit or ambit of the invention.

It will be also understood that where the word “comprise”, and variations such as “comprises” and “comprising”, are used in this specification, unless the context requires otherwise such use is intended to imply the inclusion of a stated feature or features but is not to be taken as excluding the presence of other feature or features.

The reference to any prior art in this specification is not, and should not be taken as, an acknowledgment or any form of suggestion that such prior art forms part of the common general knowledge.

What is claimed is:

1. A device, for aligning the handlebars of a bicycle relative to the bicycle's front wheel, said device including:
a unitary body, and
a laser beam emitter,
wherein the unitary body includes a base portion that enables the unitary body to at least sit upon the handlebars, and said base portion provides the device with a stable and accurate foundation upon which the device is able to be operated by a user, and wherein said laser beam emitter generates a beam in the visible light spectrum so that wherever the beam makes contact with the front wheel, or the bicycle frame, or another component attached to the bicycle frame, it creates a visible point of light, said laser beam emitter is mounted inside the unitary body on a first transverse shaft, and the first transverse shaft runs parallel to the handlebars, so that the laser beam emitted from said laser beam emitter is perpendicular to the first transverse shaft, and said laser beam emitter is capable of being rotated inside the unitary body about the first transverse shaft so that the angle of declination or inclination that the emitted laser beam produced by the laser beam emitter makes relative to the handlebars is able to be changed by the user, thereby causing the visible point of light to be movable by the user, and the user can then make fine adjustments to the alignment of the handlebars, relative to the front wheel, and/or another component that is mounted on the bicycle frame, relative to the bicycle frame.

2. A device as claimed in claim 1 wherein the base portion is located at the lower end of the unitary body and consists of a pair of forks that overlay the top of the handlebars.

3. A device as claimed in claim 2 wherein the unitary body includes an alternative engagement portion that extends laterally to the vertical axis of the unitary body, and when used, the alternative engagement portion permits the user to place the device onto the front or rear of the handlebars while ensuring stable support for the device, relative to the handlebars, and also ensuring the transverse shaft remains parallel with the handlebars.

4. A device as claimed in claim 3 wherein the alternative engagement portion includes a pair of spring biased slidable clamps that are capable of being opened by an operator, allowing the operator to place the device on the handlebars, with a portion of the handlebars located within the pair of clamps, so that when the clamps are released, the resulting clamping action upon the portion of the handlebars is sufficient to hold the device in place.

5. A device as claimed in claim 2 wherein at least the handlebar contacting surfaces of the device are fabricated from a material that mitigates the likelihood that the contact between the device and the handlebars will damage or mar the surface finish of the handlebars, regardless of the material from which the handlebars are fabricated.

6. A device as claimed in claim 5 wherein once the handlebars are precisely aligned, relative to the front wheel, and the front wheel is precisely aligned relative to the bicycle frame, the emitted laser beam can then be used to align other components attached to the bicycle frame, such as a bicycle seat for example.

7. A device a claimed in claim 6 wherein fine adjustment means are included to adjust the first transverse shaft relative to the handlebars to enable the user to adjust the direction of the emitted laser beam to ensure it is perpendicular to the line of the handlebars at all angles of inclination and declination.

8. A device as claimed in claim 7 wherein the unitary body includes additional attachment means that enable the device to be removably attached to the handlebars.

9. A device as claimed in claim 8 wherein the additional attachment means are elastic straps that are attached to the unitary body at one end, and then once the device is placed into contact with the handlebars, the elastic straps are able to be stretched around the handlebars, then re-attached to the unitary body at the other end, thereby holding the unitary body in contact with the handlebars.

10. A device as claimed in claim 9 wherein a first mirror can be optionally installed at a desired location on the bicycle so that the laser beam emitted from the laser beam emitter can be reflected off the first mirror to a location on the bicycle frame, or a component attached to the frame, that the direct beam generated by the laser emitter would not be able to contact directly due to an obstruction by either the bicycle frame, or a component attached to the frame.

11. A device as claimed in claim 10 wherein the first mirror is attached to a second transverse shaft, and the second transverse shaft is calibrated to run parallel to the handle bars so that the laser beam reflected off the mirror remains perpendicular to the handlebars.

12. A device as claimed in claim 11 wherein the first mirror is rotatable about the second transverse shaft so that the angle of inclination or declination of the reflected laser beam can be adjusted by the user, thereby causing the point of light generated by the reflected laser beam on either the frame or a component attached to the frame, to be movable.

13. A device as claimed in claim 12 wherein a second mirror is optionally installed at another desired location on the bicycle so that the reflected laser beam from the first mirror is able to be directed onto the second mirror so that the laser beam emitted from the laser beam emitter can be reflected off the second mirror to a location on the frame, or a component attached to the frame, that the direct beam generated by the laser emitter, or the beam reflected off the first mirror, would not be able to contact directly due to an obstruction by either the bicycle frame, or a component attached to the frame.

14. A device as claimed in claim 13 wherein the second mirror is attached to a third transverse shaft, and the third transverse shaft is calibrated to also run parallel to the handle bars so that the laser beam reflected off the second mirror remains perpendicular to the handlebars.

15. A device as claimed in claim 14 wherein the second mirror is rotatable about the third transverse shaft so that the angle of inclination or declination of the reflected laser beam off the second mirror can be adjusted by the user, thereby causing the point of light generated by the reflected laser beam on either the frame or a component attached to the frame, to be movable. pg,18

16. A device as claimed in claim 15 wherein the first mirror is located near a forward portion of the bicycle frame, or a component attached to the frame, such as the front forks, and the second mirror is located near a rearward portion of the bicycle frame, or a component attached to the frame, so that the laser beam generated by the laser beam emitter can be used to check the “squareness” of the bicycle frame.

17. A device as claimed in claim 16 wherein the device uses the centre bolt on the handlebars mounting stem for its mounted position.
